(19) United States
(12) Patent Application Publication
(10) Pub. No.: US 2019/0213654 A1
(43) Pub. Date: Jul. 11, 2019

(54) Customer Engagement Platform For Providing Enhanced Content

(71) Applicant: Penguin Magic, Inc., Columbus, OH (US)

(72) Inventor: Acar Altinsel, Ann Arbor, MI (US)

(21) Appl. No.: 15/866,087

(22) Filed: Jan. 9, 2018

(51) Int. Cl. G06Q 30/06; H04N 21/234; G06Q 20/12

(52) U.S. Cl. CPC G06Q 30/0621; G06Q 20/123; H04N 21/23424; G06Q 30/0641

(57) ABSTRACT

The disclosed technology addresses the need in the art for providing enhanced content to an e-commerce customer. A system is configured to receive an event notification from an e-commerce platform and identify a content item based on the event notification. The system retrieves personalization data associated with the event notification and generates an enhanced version of the content item using the personalization data. The enhanced version of the content items is the provided for delivery to a customer of the e-commerce platform.

### TECHNICAL FIELD

The present disclosure pertains to customer engagement technologies, and more specifically to a customer engagement platform for providing customized content to a customer.

### BACKGROUND

Current technologies have overcome many of the technical obstacles associated with doing business or performing certain commercial-related tasks over the internet. Indeed, a large portion of commerce now takes place, either wholly or in part, on e-commerce platforms that leverage various computer technologies. However, as these technologies mature and use becomes more widespread, additional needs and technical problems appear. For example, while e-commerce platforms can scale quite readily, they have difficulty effectively engaging customers and the computer technologies available to help e-commerce platforms engage their customers face various technological hurdles.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only example embodiments of the disclosure and are not therefore to be considered to be limiting of its scope, the principles herein are described and explained with additional specificity and detail through the use of the accompanying drawings in which:

FIG. 1 is a conceptual block diagram illustrating an example network environment, in accordance with various embodiments of the subject technology;

FIG. 2 is a conceptual block diagram illustrating an example customer engagement platform, in accordance with various embodiments of the subject technology;

FIG. 3 is an illustration of a content item, in accordance with various embodiments of the subject technology;

FIG. 4 is an illustration of an enhanced content item, in accordance with various embodiments of the subject technology;

FIG. 5 shows an example method for providing enhanced content to a customer, in accordance with various embodiments of the subject technology; and

FIG. 6A and FIG. 6B show example possible system embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for a more effective customer engagement technologies configured to interact with an e-commerce platform over a network in order to generate and provide enhanced content to customers of the e-commerce platform. The enhanced content is designed to be personalized to customers and/or provide information that has been shown to increase customer engagement with the e-commerce platform.

Customer engagement may be a measure of affinity or interaction between one entity (e.g., an e-commerce platform, a brand, a product, a company, an organization) and another entity (e.g., a customer, a consumer, a user, or other stakeholder). Customer engagement may be measured by, for example, a number or frequency of interactions, purchases, responses, visits, transactions, views, likes, or other statistic (e.g., a likelihood of returning). Customer engagement may also be measured via ratings, polls, surveys, or any combination of a number of measures.

According to various embodiments of the subject technology, the customer engagement platform is configured to receive an event notification from an e-commerce platform and identify a content item based on the event notification. The customer engagement platform retrieves personalization data associated with the event notification and generates an enhanced version of the content item using the personalization data. The enhanced version of the content items is the provided to a customer of the e-commerce platform.

These and other embodiments address various technical problems in the computing field as well. For example, the various approaches taken address the shortcomings in the various application program interfaces (APIs) provided by e-commerce sites and/or structural limitations of the data models maintained by certain e-commerce sites that prevent robust querying of data sets. Additionally, approaches further reduce the bandwidth and processing time required to perform various functions.

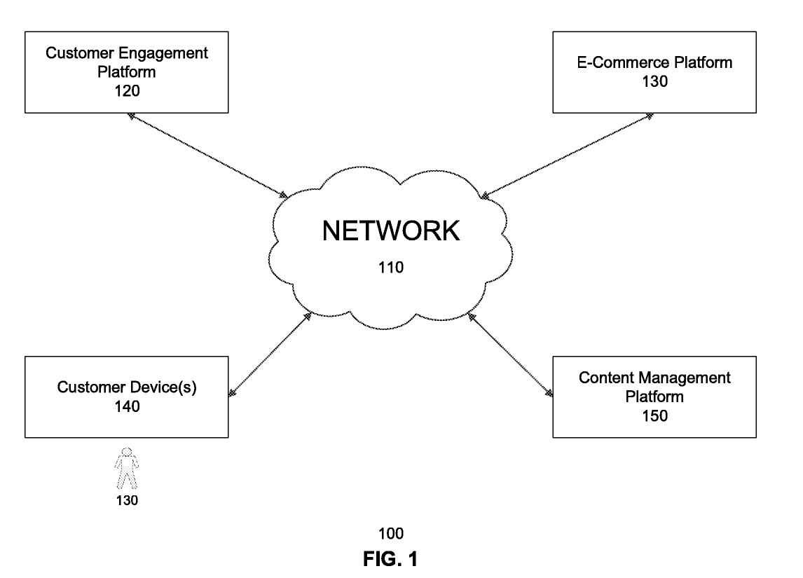

FIG. 1 is a conceptual block diagram illustrating an example network environment 100, in accordance with various embodiments of the subject technology. Although FIG. 1 illustrates a client-server network environment 100, other embodiments of the subject technology may include other configurations including, for example, peer-to-peer environments or single-system environments.

The network environment 100 includes a customer engagement platform 120, one or more e-commerce platforms 130, and one or more customer devices 140. In some embodiments, the network environment 100 may also include a content management platform 150. The customer engagement platform 120, the e-commerce platforms 130, the content management platform 150, and the customer devices 140 may communicate via a network 110.

The one or more e-commerce platforms 130 may be configured to perform one or more commercial transactions or business activities. The e-commerce platforms 130 may be involved with online marketplaces, retail sales, business-to-business sales, purchase of goods and/or services, or other such transactions. During the course of business, the e-commerce platforms 130 may generate or be notified of one or more events. Events may include, for example, purchase events, shipping events, delivery events, return events, payment events, follow-up events, or any other event associated with the e-commerce platform. Additional events may include, for example, visits from an identified customer to a website associated with an e-commerce platform 130, receiving a rating or review for a product or service provided by the e-commerce platform 130 or for the e-commerce platform 130 itself, or other event, action, or activity that may be detected by the e-commerce platform 130.

Although various embodiments are directed towards marketplace platforms, other embodiments may also be compatible with e-commerce platforms in health care environments, hospitality environments, service oriented environments, or any other environments where transactions or other discrete events occur. For example, events may also include hospital admittance or discharge events, billing or payment events, guest arrival or check-in events, guest departure or check-out events, guest reservation events, guest cancellation events, etc. Furthermore, not every activity of the e-commerce platforms 130 may occur on the computing and/or networking environment of FIG. 1. For example, portions or subsets of activities may occur offline as long as at least one event is generated by the online portion of the e-commerce platform 130.

In some embodiments, an e-commerce platform 130 may provide an interface (e.g., an API) that enables the customer engagement platform 120 to request and retrieve information such as, in the retail environment, product information, order information, customer information, and/or content. The e-commerce platform 130 may also be configured to detect the various events that occur and transmit an event notification for the detected event to the customer engagement platform 120.

The event notification may include an event type or descriptor, a customer identifier, and any other information associated with the event. For example, additional information may include a timestamp for the event, a message for the customer, contact information for the customer (e.g., an email address, phone number, mailing address, social media identifier, etc.), a customer name, transaction details (e.g., a product or service purchased, rented, or returned, terms of the transaction, etc.), customer preferences, or any other information that may be used to enhance content for the customer.

The customer engagement platform 120 may be configured to receive an event notification from an e-commerce platform 130 and identify a content item based on the event notification. According to some embodiments, the customer engagement platform 120 may include a mapping of an e-commerce platform 130 and event type to a content item. The content item may be provided to the customer engagement platform 120 previously by the e-commerce platform 130, provided by the customer engagement platform 120, or provided by the content management platform 150.

The customer engagement platform 120 retrieves personalization data associated with the event notification and generates an enhanced version of the content item using the personalization data. The personalization data may be provided in the event notification, requested by the customer engagement platform 120 from the e-commerce platform, or previously obtained by the customer engagement platform 120 from the e-commerce platform and/or a third-party.

To help illustrate, in some embodiments, the content item may be a video thanking customers of an e-commerce site for a recent purchase. The video may include a person (e.g., an e-commerce site employee) holding up a blank sign and saying “thank you for your purchase.” The personalization data may be, for example, the customer's first name. The customer engagement platform 120 may be configured to render realistic text in the blank sign of the video that reads, “Thank you [insert customer first name]!” in a way that tracks the movement of the blank sign in the video such that the it appears as if the text was actually printed on the sign in the video.

Once the enhanced version of the content item is generated, the customer engagement platform 120 may deliver the enhanced content item to the customer via the customer contact information provided in the event notification or otherwise obtained by the customer engagement platform 120. For example, the content may be attached or embedded in an email and emailed to the customer such that the customer can view the enhanced content on a customer device 140.

In other variations, the content may be uploaded to a content management platform 150 and a link to the uploaded content may be generated and provided to the customer. For example, the link may be posted on a social media page associated with the customer, messaged to the customer using a text messaging or instant messaging service, or included in the email to the customer along with a preview of the uploaded content. In other embodiments, the content may be provided in any other means (e.g., through mail, etc.).

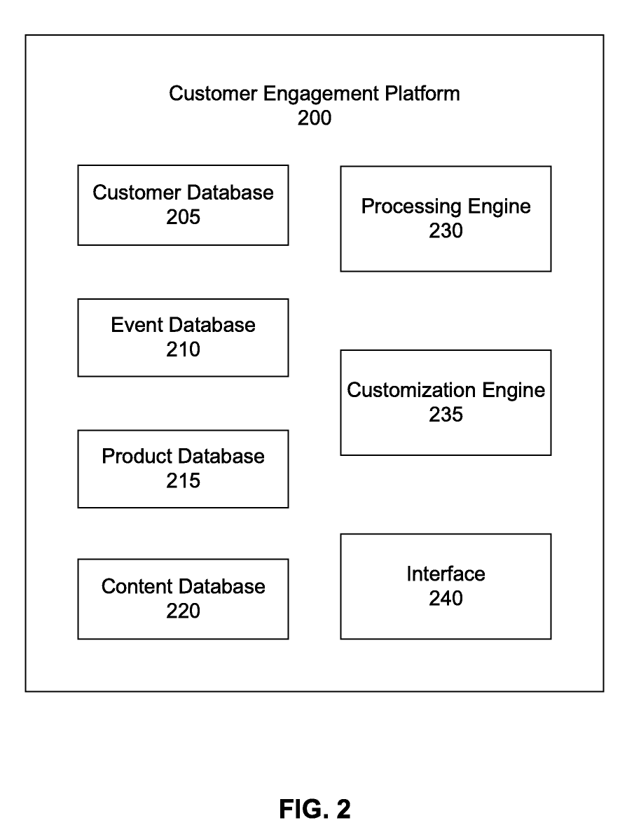

FIG. 2 is a conceptual block diagram illustrating an example customer engagement platform 200, in accordance with various embodiments of the subject technology. The customer engagement platform 200 may include a processing engine 230, a customization engine, and an interface 240. The customer engagement platform 200 may further include various databases or means for accessing various databases including, for example, a customer database 205, an event database 210, a product database 215, and a content database 220.

The data in the customer database 205, the event database 210, the product database 215, and/or the content database 220 may be populated in batch processes by querying one or more e-commerce platforms or third-party data providers and/or gradually by storing information contained in event notifications received over time. According to some embodiments, much of the information available to the e-commerce platform is replicated and stored locally in order to address the technical problem of e-commerce platforms not providing sophisticated APIs and backend functionality that enable fast and efficient querying.

Storing the information locally allows for reduced bandwidth, fewer queries to the e-commerce platforms, and reduction in processing time among other things. Furthermore, storing the information locally allows for more complex queries of the local data stores, which allows for more efficient and powerful segmentation and targeting of the customers that will receive content or events that will generate the delivery of content. For example, targeting customers of one e-commerce platform that are in Colorado, have purchased Product A in the last 3 months, and are “high-value” customers to the e-commerce platform can be performed more quickly and efficiently.

The customer database 205 is configured to store information about customers of one or more e-commerce platforms. Each customer may be keyed to a customer id and the customer database 205 may include information for the customer such as a customer name, contact information (e.g., an email, mailing residence, social media account identifier, phone number, etc.), customer preferences, customer demographic information, customer activity information across one or more platforms, customer tags provided by the e-commerce platform (e.g., the customer is tagged as a “high value,” “new,” “repeat,” and/or “first purchase” customer), the number of times or frequency that a customer purchases a certain product or service, etc.

According to some embodiments, the customer database 205 may also keep track of which content items that a customer has viewed so that different content may be sent to the customer each time. For example, for each of one or more notification event types, the customer database 205 may store a list of content identifiers associated with content items that have been provided to a customer, the number of content items associated with the notification event type that have been provided to the customer, or a count that increments each time the customer has been provided a content item associated with the event type. This information may be updated by the customer engagement platform 200 each time a content item is provided to the customer.

The event database 210 is configured to store information about transactions, orders, or other events for one or more e-commerce platforms. Each event may be associated with one or more entries in the event database 210 that are keyed to an event id and may include information such as a time that the event occurred, an associate product (e.g., via a product identifier) or service associated with the event, a representative of the e-commerce platform that may have helped or otherwise been associated with the event, or any other information associated with the event that may be helpful in personalizing or otherwise enhancing content items for delivery to the customer.

The product database 215 is configured to store information about products of one or more e-commerce platforms. Each product may be keyed to a product id and include information such as the product name, product description, ratings or reviews, specifications, warnings, warranties, related products or services, how often a product is purchased, etc.

Although the customer engagement platform 200 is shown with a product database 215 to support e-commerce platforms, other additional or alternative databases (e.g., service databases, property databases, etc.) may also be used when dealing with other types of platforms that generate events supported by the customer engagement platform 200.

The content database 220 may include a mapping for the source platform of an event type to an identifier for a content item. According to some embodiments, the mapping to the identifier for the content item may include additional factors such as a product or service identifier for the product or service purchased, a current season or time period, or customer information. The customer information may include customer preferences, a count of how many items or services the customer has purchased, a count of or identifiers for content items that the customer has already received, customer demographic information (e.g., age, city or state of residence, etc.), information about other customer interactions with the source platform, notes about the customer, etc.

The content database 220 may also store numerous content items that may be provided to customers. In some embodiments, the content database 220 may store identifiers to the content items as well as references (e.g., links or pointers) to content items stored in other locations (e.g., other databases or on external content management platforms).

The interface 240 may be configured to receive and transmit data with the external parties such as e-commerce platforms, content management platforms, customer devices, third-party data providers, or messaging servers (e.g., email, instant messaging, text messaging, or social media servers). For example, the interface 240 may receive event notifications from one or more external parties and transmit content for delivery to a customer.

The processing engine 230 is configured to identify a content item for delivery to a customer based on the event notification. For example, the event notification may identify a source platform (e.g., the e-commerce platform that generated the event notification), a customer identifier, and an event type. A content item may be identified based on the information in the content database 220 that maps the information contained in the event notification and/or customer information stored in the customer database 205 to a content item.

The processing engine 230 may also retrieve personalization data associated with the event notification. The personalization may be included in the event notification, in the customer database 205, or retrieved via the interface 240 from a third-party customer data store. In a simple illustration, the event notification may include a customer identifier which may be used to query the customer database 205 for personalization information such as a customer first name and/or a message. Personalization information may also include any of the other customer information in the customer database 205 that may be used to personalize the content item to be delivered to the customer such as customer preferences, a count of how many items or services the customer has purchased, or information about content items that the customer has already received.

The processing engine 230 may pass an identifier of the content item and the personalization data to the customization engine 235. The customization engine 235 may retrieve the content item using the content item identifier from the content database 220 or wherever the content is stored (e.g., an external content management platform) and generate an enhanced version of the content item based on the personalization data. The content item may be an image or video thanking customers or users of the source platform, reminding the customer or users of an upcoming event or visit, or any communication that may aid in customer engagement.

The video may include a person (e.g., an e-commerce site employee) holding up a blank sign and saying “thank you.” The personalization data may be, for example, the customer's first name and or a message such as “Thank you [variable for customer first name] for your purchase of [variable for product purchased],” “Thank you [variable for customer first name] for your visit,” “I hope you enjoyed the [variable for service purchased] with [variable for service professional first name]. Please come back soon,” or “Thank you [variable for customer first name] for staying with us at our [variable for venue] location.” The customization engine 235 may be configured to substitute personalization data (e.g., the customer's first name or product name) in the appropriate variable in the message and render realistic message with the substituted personalization data in the blank sign of the video as if the text was actually printed on the sign in the video.

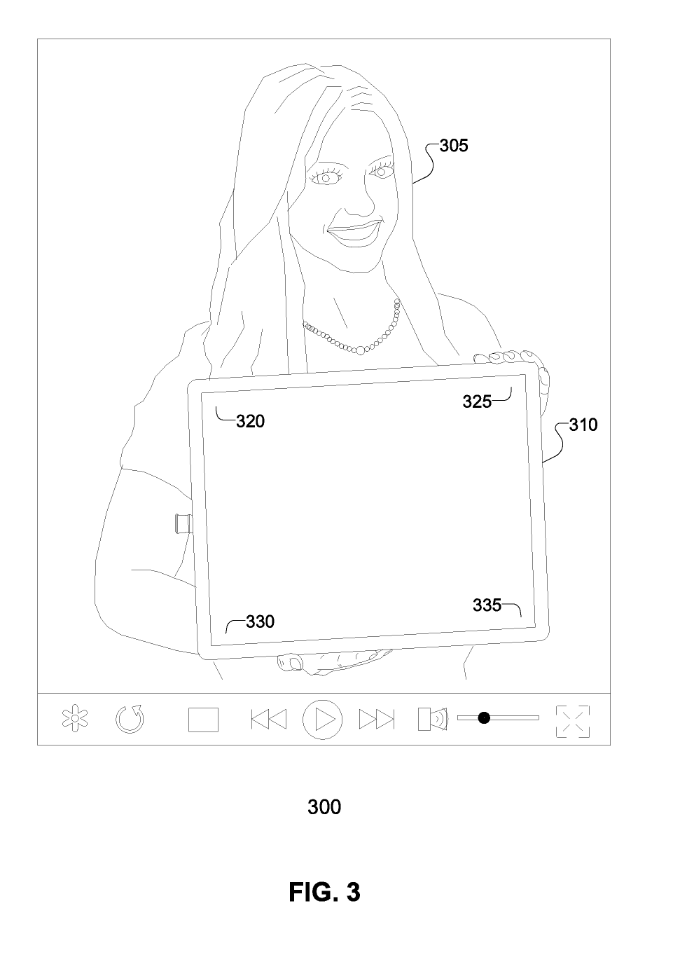

FIG. 3 is an illustration of a content item 300, in accordance with various embodiments of the subject technology. The content item 300 shown is a video of a person 305 with a blank sign area 310 where customized text may be rendered. According to some embodiments, the content item 300 may include track points 320, 325, 330, and 335 that mark an area in the content item where text is to appear or be bounded by. For example, in content item 300, the track points 320-335 mark the corners of the blank sign area 310 where text is to be rendered within. The track points 320-335 may be dots of a particular color (e.g., a particular shade of green) and/or shape, aruco markers, codes, or other visual signifier. The customization engine may track these track points 320-335 throughout the video content to determine the size, location, angle, and other factors needed to render text realistically within the area. The customization engine is able to manipulate the text to follow those track points 320-335 to appear realistic.

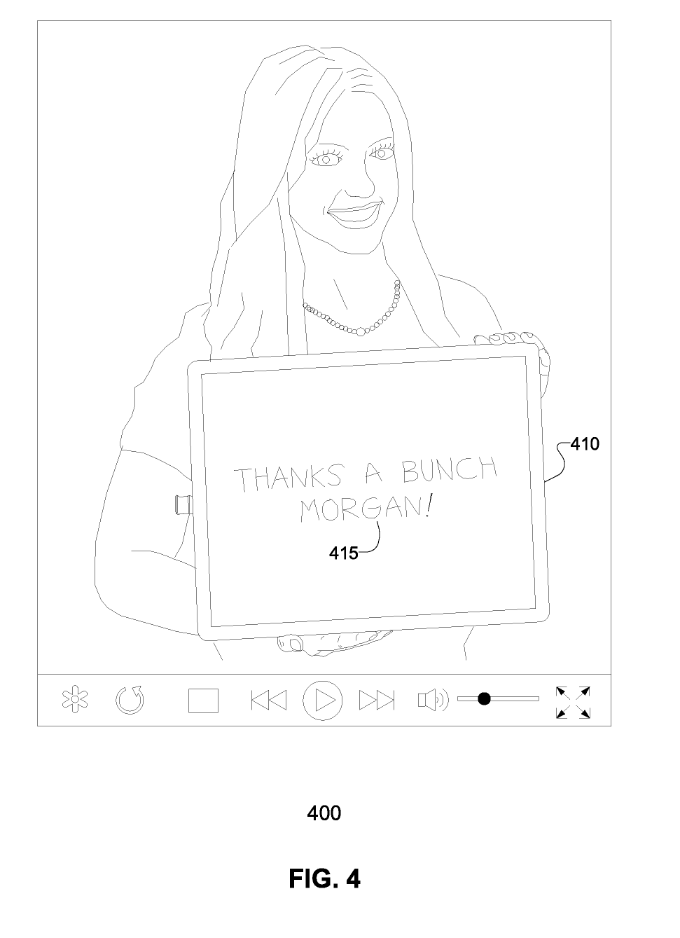

For example, FIG. 4 is an illustration of an enhanced content item 400, in accordance with various embodiments of the subject technology. In FIG. 4, the enhanced content item 400 is personalized to include a personalized message 415 in the sign area 410. As the video plays, the personalized message 415 tracks the movement and appearance of the sign area to look more realistic.

Although FIGS. 3 and 4 show the content item as a video, in other embodiments, the content item may be an image, an audio track, a slide show, a document, or any other item of content. Furthermore, the enhancement to the content item may not be limited to personalization of the content item by adding text. Instead, other enhancements such as image processing and manipulation, audio editing, or content formatting based on customer preferences may also or alternatively be done.

According to some embodiments, track points need not be used. Instead, the system may automatically detecting a writing surface and/or fabricate the writing surface in the video.

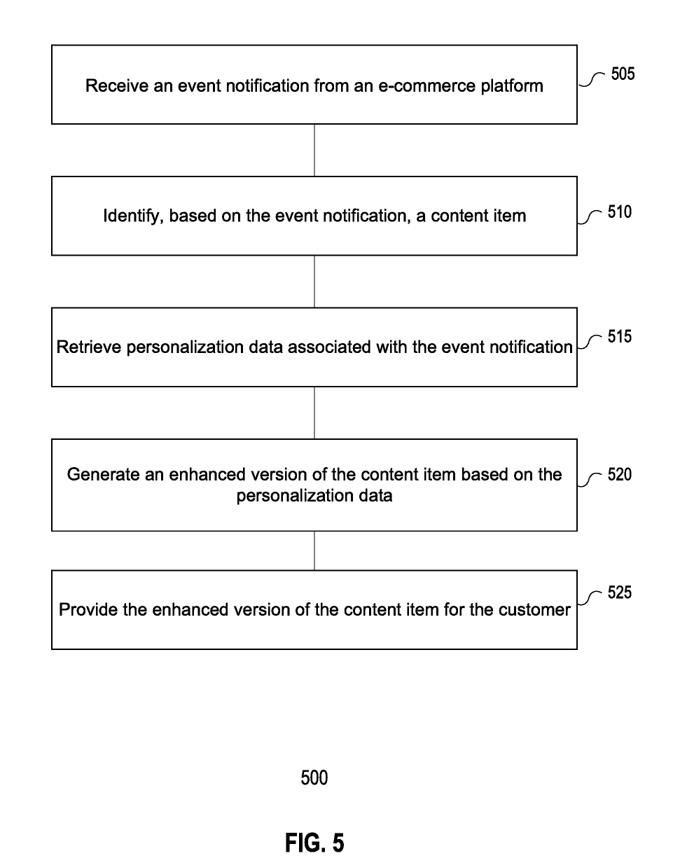

FIG. 5 shows an example method 500 for providing enhanced content to a customer, in accordance with various embodiments of the subject technology. Although the methods and processes described herein may be shown with certain steps and operations in a particular order, additional, fewer, or alternative steps and operations performed in similar or alternative orders, or in parallel, are within the scope of various embodiments unless otherwise stated. Method 500 may be implemented by a system which may be embodied as, for example, one or more servers associated with a customer engagement platform.

At operation 505, the system receives an event notification from an e-commerce platform. The event notification is associated with an event detected by the e-commerce platform for which a communication is to be generated and delivered to a customer. At operation 510, the system identifies a content item based on the received event notification. In a simple example, the content item may simply be identified based on receiving the event notification. In other embodiments, the content item may be selected based on various data such as the platform from which the event notification is received, an event type, a customer identifier, a product or service identifiers, etc.

In some embodiments, assuming there are multiple content items that are applicable, the system may track which content items a customer has viewed, received, or been sent so that the system may select a content item that the customer that has not seen or has not seen recently. For example, when a content item is sent to a customer, a content identifier for the sent content item may be recorded in a customer entry for the customer in the customer database. When subsequent event notifications associated with the customer are received, the system may look up the content identifiers for the content items that the customer has already received and select a content item that is not listed or is not listed recently.

In other embodiments, the customer entry may store a counter of content items that the customer has received and each time the customer is sent a new content item, the counter may be incremented. The content database may also store an ordered list of appropriate content items (e.g., content items for a particular type or category of notification events). When subsequent event notifications associated with the customer are received, the system may select the next content item in the ordered list based on the counter in the customer entry.

The system also retrieves personalization data associated with the event notification at operation 515. Some or all of the personalization data may be included in the received event notification or retrieved from the databases or a third-party using information in the event notification (e.g., a customer identifier). At operation 515, the system generates an enhanced version of the content item based on the personalization data.

As described above, the content item may be a video thanking customers of an e-commerce site for a recent purchase. The video may include a person (e.g., an e-commerce site employee) holding up a blank sign and saying “thank you for your purchase.” The personalization data may be, for example, the customer's first name. The customer engagement platform 120 may be configured to render realistic text in the blank sign of the video that reads, “Thank you [insert customer first name]!” in a way that tracks the movement of the blank sign in the video such that the it appears as if the text was actually printed on the sign in the video.

At operation 525, the system may provide the enhanced content item to the customer. For example, the enhanced content item may be emailed to the customer's email account, uploaded to a content management system accessible using a link and the link emailed to the customer, sent via a messaging service, or posted to the customer via a social media platform.

According to some embodiments, the enhanced content may include an option or request to refer a friend. The option may redirect the customer to an interface (e.g., a reply email, a website, application, or other interface) where the customer can provide the friend's name and contact information (e.g., email address). The system may receive the information and generate one or more additional enhanced content items to provide to the friend. For example, an additional enhanced content item may be a video welcoming the friend and including both the customer's name and the friend's name.

According to various embodiments, the system may also schedule follow-up event notifications that may be triggered at a future date and time and cause the system to generate additional enhanced content for delivery to the user.

According to some embodiments, the system may also integrate with a mailing list service that allows an administrator to see various mailing lists, select one or more lists for delivery of enhanced content items, customize content items for each recipient on the selected list, and transmit the enhanced content items to each recipient on the selected list.

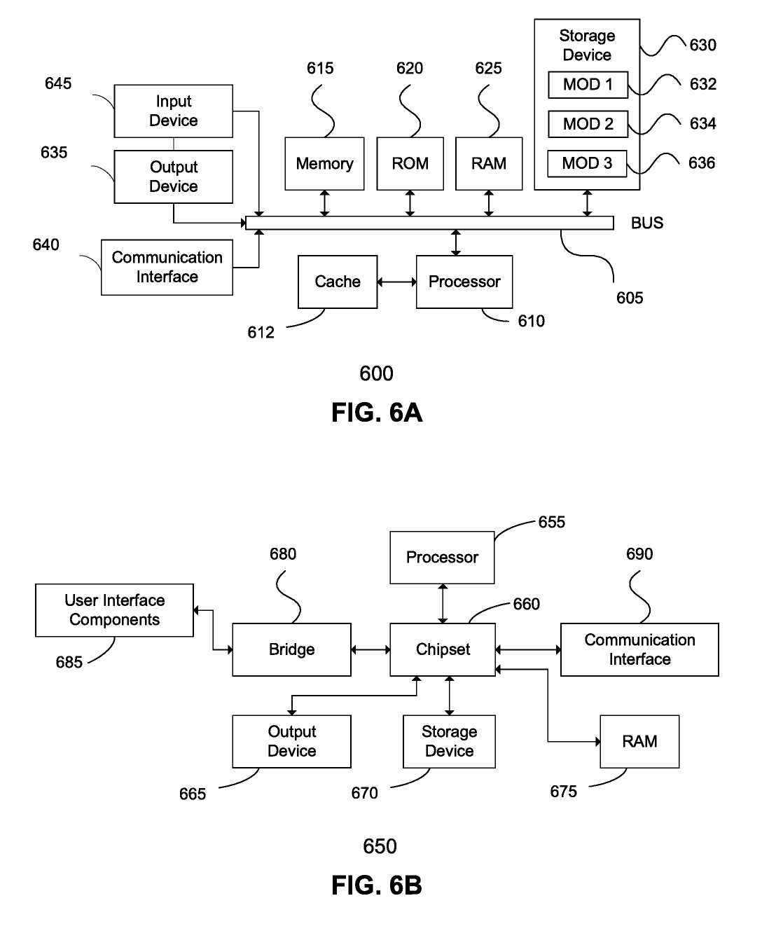

FIG. 6A and FIG. 6B show example possible system embodiments. The more appropriate embodiment will be apparent to those of ordinary skill in the art when practicing the present technology. Persons of ordinary skill in the art will also readily appreciate that other system embodiments are possible.

FIG. 6A shows a conventional system bus computing system architecture 600 wherein the components of the system are in electrical communication with each other using a bus 605. Example system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B shows a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that example systems 600 and 650 can have more than one processor or be part of a group or cluster of computing devices networked together to provide greater processing capability. The processor may include a central processing unit (CPU), a graphic processing unit (GPU), other processing units, or a combination thereof.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method comprising:
receiving, on a customer engagement platform, an event notification from an e-commerce platform, wherein the event notification is associated with a customer;
identifying, based on the event notification, a content item;
retrieving personalization data associated with the event notification;
generating, using the personalization data, a personalized version of the content item; and
providing, to the customer, the personalized version of the content item.

2. The computer-implemented method of claim 1, wherein the event notification is generated by the e-commerce platform in response to at least one of a shipping event, a transaction event, or a follow-up event.

3. The computer-implemented method of claim 1, wherein the event notification comprises a customer identifier for the customer and an event type, and wherein the content item is identified based on the customer identifier and the event type.

4. The computer-implemented method of claim 1, wherein the event notification comprises a customer identifier for the customer, the method further comprising:
retrieving, based on the customer identifier, contact information for the customer from a customer database; and
transmitting, based on the contact information, the personalized version of the content item for the customer.

5. The computer-implemented method of claim 1, wherein the event notification comprises an event type, the method further comprising identifying the content item based on a mapping of the event type to a content item.

6. The computer-implemented method of claim 1, wherein the content item includes at least an image or a video.

7. The computer-implemented method of claim 6, wherein the content item comprises an area for enhancements to the content item.

8. The computer-implemented method of claim 7, wherein the area for enhancements is defined by track points in the content item.

9. The computer-implemented method of claim 7, further comprising:
rendering, using the personalization data, personalized text in the area for enhancements.

10. The computer-implemented method of claim 1, further comprising:
uploading the personalized version of the content item to a content management platform;
retrieving a link to the personalized version of the content item; and
transmitting the link to the personalized version of the content item to the customer.

11. The computer-implemented method of claim 1, further comprising storing, in an entry for the customer in a customer database, a content identifier associated with the content item.

12. A non-transitory computer-readable medium comprising instructions, the instructions, when executed by a computing system, cause the computing system to:
receive an event notification from a source platform, wherein the event notification is associated with a customer;
identify, based on the event notification, a content item;
retrieve enhancement data associated with the event notification;
generate, using the enhancement data, an enhanced version of the content item; and
provide, to the customer, the enhanced version of the content item.

13. A system comprising:
a processor; and
a non-transitory computer-readable medium storing instructions that, when executed by the system, cause the system to:
receive an event notification comprising an event type and a customer identifier;
select a content item from a first set of content items based on a mapping of the event type to the content item;
retrieve, based on the customer identifier, enhancement data associated with the event notification;
generate, using the enhancement data, an enhanced version of the content item; and
provide the enhanced version of the content item for delivery to a customer associated with the customer identifier.

14. The system of claim 13, wherein the non-transitory computer-readable medium further stores instructions that, when executed by the system, cause the system to:
identify a second set of content items delivered to the customer based on a customer entry in a customer database, wherein the content item from the first set of content items is not in the second set of content items delivered to the customer.

15. The system of claim 13, wherein the non-transitory computer-readable medium further stores instructions that, when executed by the system, cause the system to:
store, in a customer entry in a customer database, a content identifier associated with the enhanced version of the content item.

16. The system of claim 13, wherein the content item includes at least an image or a video.

17. The system of claim 13, wherein the content item comprises an area for enhancements to the content item and wherein the area for enhancements is defined by track points in the content item.

18. The system of claim 17, wherein the non-transitory computer-readable medium further stores instructions that, when executed by the system, cause the system to:
render, using the enhancement data, personalized text in the area for enhancements.

19. The system of claim 13, wherein the non-transitory computer-readable medium further stores instructions that, when executed by the system, cause the system to:
uploading the enhanced version of the content item to an e-commerce platform for delivery.

20. The system of claim 13, wherein the non-transitory computer-readable medium further stores instructions that, when executed by the system, cause the system to:
transmit a link to the enhanced version of the content item to the customer.
